(19) United States
(12) Patent Application Publication
(10) Pub. No.: US 2026/0018917 A1
(43) Pub. Date: Jan. 15, 2026

(54) CONTROL DEVICE FOR CHARGING SYSTEM

(71) Applicant: TOYOTA JIDOSHA KABUSHIKI KAISHA, Toyota-shi (JP)

(72) Inventor: Yukinori MURAKAMI, Toyota-shi (JP)

(21) Appl. No.: 19/063,812

(22) Filed: Feb. 26, 2025

(30) Foreign Application Priority Data
Jul. 12, 2024 (JP) 2024-112184

(51) Int. Cl. H02J 7/00; H02J 7/35

(52) U.S. Cl. CPC H02J 7/007188; H02J 7/00047; H02J 7/0013; H02J 7/005; H02J 7/35; H02J 2207/20

(57) ABSTRACT

A control device of a charging system is configured to execute acquiring a first index value indicating a deterioration degree of a low-voltage battery of the charging system, acquiring a second index value indicating a degree of whether or not a state in which the low-voltage battery is placed is a state in which the state is likely to deteriorate, and setting a specified range that is a range of input and output power to the low-voltage battery based on the first index value and the second index value.

### CROSS-REFERENCE TO RELATED APPLICATION

This application claims priority to Japanese Patent Application No. 2024-112184 filed on Jul. 12, 2024. The disclosure of the above-identified application, including the specification, drawings, and claims, is incorporated by reference herein in its entirety.

### BACKGROUND

### 1. Technical Field

The present disclosure relates to a control device for a charging system.

### 2. Description of Related Art

The vehicle of Japanese Unexamined Patent Application Publication No. 2021-083248 (JP 2021-083248 A) includes a solar panel, a high-voltage battery, a low-voltage battery, an electric motor, an auxiliary equipment, a DCDC converter, and a control device. The solar panel is configured to generate power by being irradiated with sunlight. The high-voltage battery is charged by receiving power from the solar panel. The high-voltage battery is a secondary battery for supplying power to an electric motor that is a drive source of a vehicle. The low-voltage battery is charged by receiving the power from the solar panel. The low-voltage battery is a secondary battery for supplying power to the auxiliary equipment. A rated voltage of the low-voltage battery is lower than a rated voltage of the high-voltage battery. The DCDC converter is configured to convert the power from the solar panel into a voltage to output the voltage.

The control device controls the DCDC converter to supply the power from the solar panel to the high-voltage battery, the low-voltage battery, and the auxiliary equipment. Specifically, the control device determines whether a generated power value of the solar panel is equal to or greater than a predetermined specified power value. The control device supplies the power from the solar panel to the auxiliary equipment or the low-voltage battery under a requirement that the generated power value is less than the specified power value. On the other hand, the control device supplies the power from the solar panel to the high-voltage battery as well as the auxiliary equipment or the low-voltage battery, under a requirement that the generated power value is equal to or greater than the specified power value.

### SUMMARY

In the charging system of JP 2021-083248 A, whether the power from the solar panel is supplied to the low-voltage battery and the high-voltage battery is determined by the generated power value of the solar panel. On the other hand, in the charging system of JP 2021-083248 A, the aspect of what state the battery is in is not taken into consideration in inputting and outputting the power to the battery. Therefore, the charging system of JP 2021-083248 A does not always allow for charging or discharging the battery in a suitable state.

A control device for a charging system of a first aspect of the disclosure includes a solar panel, a first converter, a low-voltage battery, a second converter, and a high-voltage battery. The solar panel is configured to generate power by receiving irradiation of sunlight. The first converter is configured to convert a voltage of the power from the solar panel and output voltage-converted power. The low-voltage battery is configured to be charged by receiving the power from the first converter. The second converter is configured to convert a voltage of the power from the first converter and a voltage of power from the low-voltage battery and output voltage-converted power. The high-voltage battery is configured to be charged by receiving the power from the second converter. The control device is configured to execute acquiring a first index value that indicates a deterioration degree of the low-voltage battery. The control device is configured to execute acquiring a second index value that indicates a degree of whether a state in which the low-voltage battery is placed is a state in which the low-voltage battery is likely to deteriorate. The control device is configured to execute setting a specified range that is a range of input and output power with respect to the low-voltage battery based on the first index value and the second index value.

With the configuration, the input and output power with respect to the low-voltage battery can be adjusted according to the first index value and the second index value, in other words, according to the state related to the deterioration of the low-voltage battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle;

FIG. 2 is a flowchart showing the power generation control;

FIG. 3 is a flowchart showing the setting control; and

FIG. 4 is a diagram illustrating a flow of power in the vehicle.

### DETAILED DESCRIPTION OF EMBODIMENTS

### Outline Configuration of Vehicle

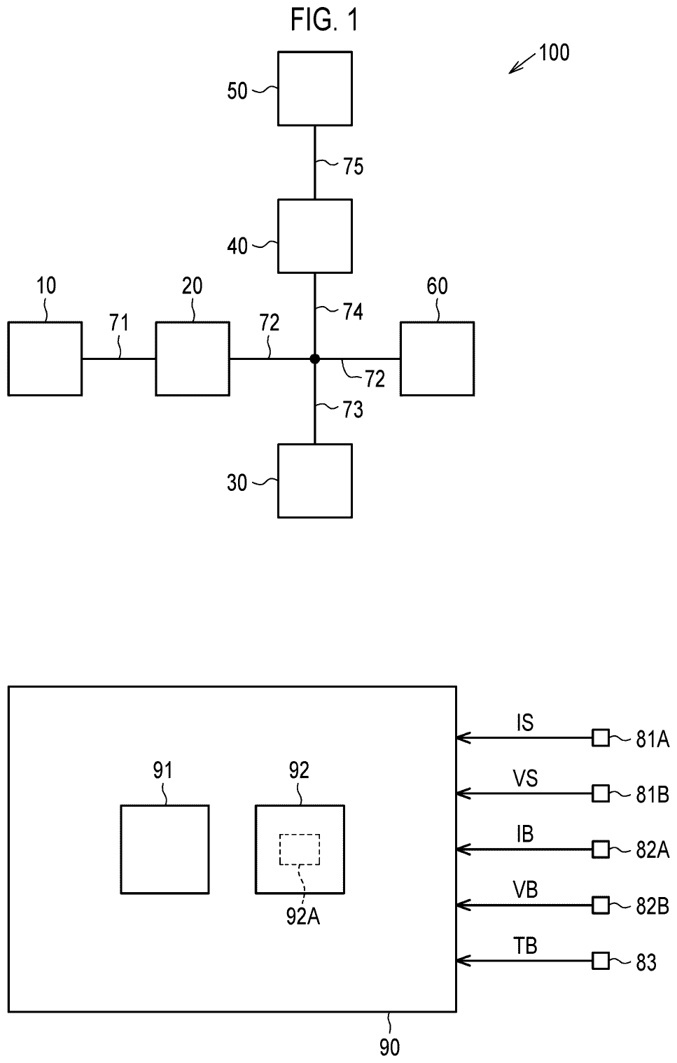

The embodiment of the present disclosure will be described below with reference to FIGS. 1 to 4. First, a general configuration of a vehicle 100 to which a charging system is applied will be described.

As shown in FIG. 1, the vehicle 100 includes a solar panel 10, a solar converter 20, a low-voltage battery 30, a bidirectional converter 40, a high-voltage battery 50, and an auxiliary equipment group 60. In addition, the vehicle 100 includes a first power line 71, a second power line 72, a third power line 73, a fourth power line 74, and a fifth power line 75.

The solar panel 10 is configured by arranging a plurality of solar cells that generate power by being irradiated with sunlight in a panel shape. Therefore, the solar panel 10 is irradiated with sunlight to generate power. In the present embodiment, the solar panel 10 is attached to a roof of the vehicle 100.

A first end of the first power line 71 is connected to the solar panel 10. A second end of the first power line 71 is connected to the solar converter 20. Therefore, the solar converter 20 is electrically connected to the solar panel 10.

The solar converter 20 is a device that converts the direct current power input from the solar panel 10 into a voltage and outputs the voltage. Therefore, the solar converter 20 can convert the voltage of the power from the solar panel 10 and output the power. The solar converter 20 may step down or step up the power generated by the solar panel 10. In the present embodiment, the solar converter 20 corresponds to the first converter.

A first end of the second power line 72 is connected to the solar converter 20. A second end of the second power line 72 is connected to the auxiliary equipment group 60. Therefore, the auxiliary equipment group 60 is electrically connected to the solar converter 20.

The auxiliary equipment group 60 includes a plurality of pieces of auxiliary equipment. Examples of the auxiliary equipment include an electric oil pump, a navigation system, a display device, a sound device, an air conditioner, a lighting device such as a headlight, and various sensors. The auxiliary equipment group 60 receives power supply through the second power line 72.

A first end of the third power line 73 is connected to an intermediate portion of the second power line 72. A second end of the third power line 73 is connected to the low-voltage battery 30. Therefore, the low-voltage battery 30 is electrically connected to the solar converter 20 and the like.

The low-voltage battery 30 is a secondary battery. The low-voltage battery 30 can be charged by receiving the power from the solar converter 20. The low-voltage battery 30 is a battery that supplies power to the auxiliary equipment group 60. An example of the rated voltage of the low-voltage battery 30 is about 12 V to 48 V.

A first end of the fourth power line 74 is connected to an intermediate portion of the second power line 72. A second end of the fourth power line 74 is connected to the bidirectional converter 40. Therefore, the bidirectional converter 40 is electrically connected to the solar converter 20 and the like. A first end of the fifth power line 75 is connected to the bidirectional converter 40. A second end of the fifth power line 75 is connected to the high-voltage battery 50. Therefore, the high-voltage battery 50 is electrically connected to the bidirectional converter 40.

The high-voltage battery 50 is a secondary battery. The high-voltage battery 50 can be charged by receiving the power from the bidirectional converter 40. The high-voltage battery 50 is a battery that supplies power to an electric motor as a drive source of a vehicle 100 (not shown). The rated voltage of the high-voltage battery 50 is higher than the rated voltage of the low-voltage battery 30. An example of the rated voltage of the high-voltage battery 50 is about 200 V to 250 V.

The bidirectional converter 40 is a device that converts the voltage of the direct current power input to the bidirectional converter 40 and outputs the converted voltage. In addition, the bidirectional converter 40 is a device capable of switching a supply direction of power. Therefore, the bidirectional converter 40 can step up the power input to the bidirectional converter 40 through the fourth power line 74 and supply the stepped-up power to the high-voltage battery 50. That is, the bidirectional converter 40 can boost the power input to the bidirectional converter 40 from one or more of the solar converter 20 and the low-voltage battery 30 and supply the boosted power to the high-voltage battery 50. The bidirectional converter 40 can step down the power input from the high-voltage battery 50 to the bidirectional converter 40 through the fifth power line 75 and supply the stepped-down power to the low-voltage battery 30 and one or more of the auxiliary equipment group 60. In the present embodiment, the bidirectional converter 40 is an example of a second converter that can convert the power from the first converter and the low-voltage battery 30 into a voltage and output the converted power.

As shown in FIG. 1, the vehicle 100 includes a first current sensor 81A, a first voltage sensor 81B, a second current sensor 82A, a second voltage sensor 82B, and a temperature sensor 83. The first current sensor 81A detects a first current IS, which is a current input to the solar converter 20. The first voltage sensor 81B detects a first voltage VS that is a voltage input to the solar converter 20. The second current sensor 82A detects a second current IB that is a current input and output to the low-voltage battery 30. The second voltage sensor 82B detects a second voltage VB, which is a voltage between terminals of the low-voltage battery 30. The temperature sensor 83 detects a battery temperature TB that is a temperature of the low-voltage battery 30.

The vehicle 100 includes a control device 90. The control device 90 acquires various pieces of information from the first current sensor 81A, the first voltage sensor 81B, the second current sensor 82A, the second voltage sensor 82B, and the temperature sensor 83.

The control device 90 includes an execution device 91 and a storage device 92. An example of the execution device 91 is a CPU. The storage device 92 includes a read-only ROM, a volatile RAM that can read and write data, and a non-volatile storage that can read and write data. The storage device 92 stores various programs and various data in advance. Specifically, the storage device 92 stores the control program 92A in advance as one of various programs. The execution device 91 executes various processes described below by executing a control program 92A stored in the storage device 92.

The execution device 91 of the control device 90 can control the solar converter 20, the bidirectional converter 40, the auxiliary equipment group 60, and the like by outputting the control signals to the solar converter 20, the bidirectional converter 40, the auxiliary equipment group 60, and the like.

### Power Generation Control

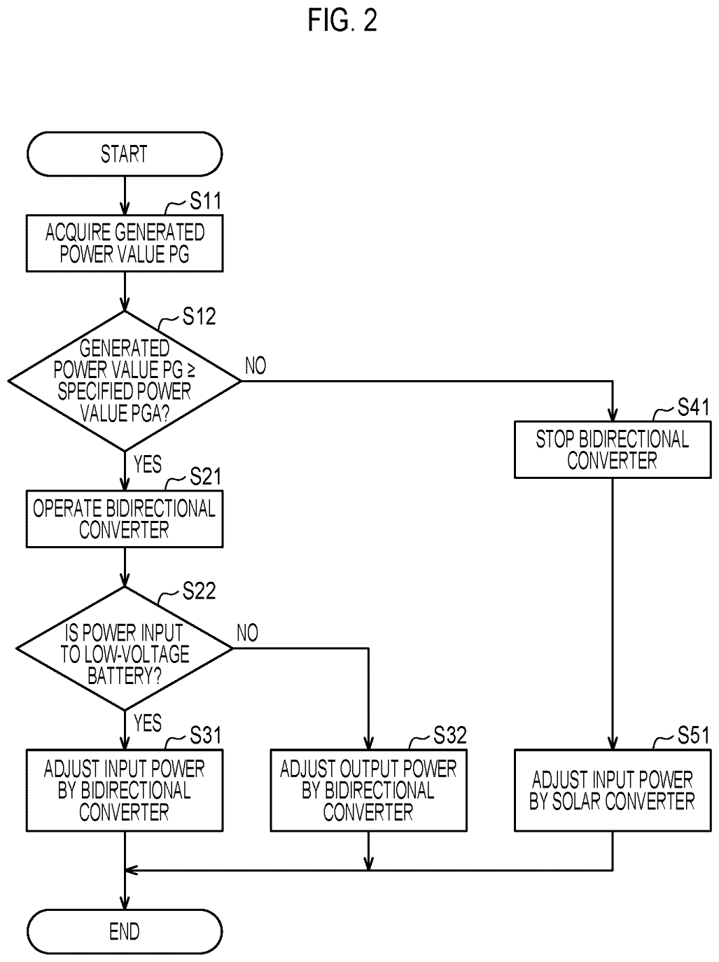

Next, power generation control executed by the control device 90 will be described with reference to FIG. 2. The power generation control is control for supplying the power generated by the solar panel 10 to each unit. In the present embodiment, the execution device 91 of the control device 90 starts the power generation control for each predetermined control cycle with the condition that the solar panel 10 is generating power.

As shown in FIG. 2, the execution device 91 of the control device 90 executes the process of S11 when the power generation control is started. In S11, the execution device 91 acquires the generated power value PG, which is a value of the power generated by the solar panel 10. In the present embodiment, the execution device 91 acquires the generated power value PG by calculating the generated power value PG based on the first current IS and the first voltage VS. After S11, the execution device 91 progresses the process to S12.

In S12, the execution device 91 determines whether or not the generated power value PG is equal to or greater than a predetermined specified power value PGA. In the present embodiment, the bidirectional converter 40 tends to have a higher conversion efficiency, which is a ratio of output power to input power of the bidirectional converter 40, as the input power of the bidirectional converter 40 is larger. Therefore, a lower limit value that can be allowed as the conversion efficiency of the bidirectional converter 40 is determined in advance. The specified power value PGA is determined in advance as a lower limit value of the generated power value PG needed to achieve the conversion efficiency equal to or higher than the lower limit value for the bidirectional converter 40. The conversion efficiency of the bidirectional converter 40 is a value obtained by dividing the output power of the bidirectional converter 40 by the input power of the bidirectional converter 40. In a case where the execution device 91 determines that the generated power value PG is equal to or greater than the specified power value PGA in S12 (S12: YES), the execution device 91 progresses the process to S21.

In S21, the execution device 91 operates the bidirectional converter 40 by outputting the control signal to the bidirectional converter 40. Specifically, the execution device 91 steps up the power input to the bidirectional converter 40 through the fourth power line 74 and supplies the stepped-up power to the high-voltage battery 50. After S21, the execution device 91 progresses the process to S22.

As shown in FIG. 2, in S22, the execution device 91 determines whether or not power is input to the low-voltage battery 30. For example, the execution device 91 determines whether or not power is being input to the low-voltage battery 30 based on the second current IB at the processing time of S22. The input and output of the power to the low-voltage battery 30 change as follows. As a premise, at the time of the process of S22, as indicated by a bold arrow in FIG. 4, the power generated by the solar panel 10 is supplied to the second power line 72 through the first power line 71 and the solar converter 20. Further, as indicated by the solid line arrow in FIG. 4, power is supplied to the high-voltage battery 50 through the fourth power line 74 and the bidirectional converter 40. Therefore, the power supplied from the solar converter 20 to the second power line 72 may be larger than the sum of the power input to the bidirectional converter 40 and the power input to the auxiliary equipment group 60. In such a case, as indicated by a one-dot chain line arrow in FIG. 4, power is input to the low-voltage battery 30. On the other hand, the power supplied from the solar converter 20 to the second power line 72 may be smaller than the sum of the power input to the bidirectional converter 40 and the power input to the auxiliary equipment group 60. In such a case, as indicated by a two-dot chain line arrow in FIG. 4, power is output from the low-voltage battery 30.

As shown in FIG. 2, in S22, when the execution device 91 determines that the power is input to the low-voltage battery 30 (S22: YES), the execution device 91 proceeds to S31 with the process. In other words, in a case where power is input to the high-voltage battery 50 through the bidirectional converter 40 and power from the solar panel 10 is input to the low-voltage battery 30 through the solar converter 20, the execution device 91 proceeds to the process S31.

In S31, the execution device 91 outputs the control signal to the bidirectional converter 40 to adjust the power input to the low-voltage battery 30 by the bidirectional converter 40. Specifically, the execution device 91 controls the power input to the high-voltage battery 50 through the bidirectional converter 40 to adjust the power input to the low-voltage battery 30 to be equal to or less than an input upper limit value LI to be described later. After S31, the execution device 91 ends the power generation control this time.

On the other hand, in S22 described above, in a case where the execution device 91 determines that the power is not input to the low-voltage battery 30 (S22: NO), the execution device 91 proceeds with the process to S32. In other words, in a case where power is input to the high-voltage battery 50 through the bidirectional converter 40 and power from the solar panel 10 is not input to the low-voltage battery 30 through the solar converter 20, the execution device 91 proceeds to the process S32.

In S32, the execution device 91 outputs the control signal to the bidirectional converter 40 to adjust the power output from the low-voltage battery 30 by the bidirectional converter 40. Specifically, the execution device 91 controls the power input to the high-voltage battery 50 through the bidirectional converter 40, and adjusts the power output from the low-voltage battery 30 to be equal to or less than an output upper limit value LO described below. After S32, the execution device 91 ends the power generation control this time.

On the other hand, in S12 described above, when the execution device 91 determines that the generated power value PG is less than the specified power value PGA (S12: NO), the execution device 91 progresses the process to S41.

In S41, the execution device 91 stops the operation of the bidirectional converter 40 by outputting the control signal to the bidirectional converter 40. Specifically, the execution device 91 stops the supply of the power through the bidirectional converter 40. After S41, the execution device 91 progresses the process to S51. In other words, the execution device 91 proceeds to the process of S51 in a case where the bidirectional converter 40 is not operated and the power from the solar panel 10 is input to the low-voltage battery 30 through the solar converter 20.

In S51, the execution device 91 outputs the control signal to the solar converter 20 to adjust the power input to the low-voltage battery 30 by the solar converter 20. Specifically, the execution device 91 controls the power output from the solar converter 20 to the second power line 72 such that the power input to the low-voltage battery 30 is adjusted to be equal to or less than an input upper limit value LI described later. After S51, the execution device 91 ends the power generation control this time.

### Setting Control

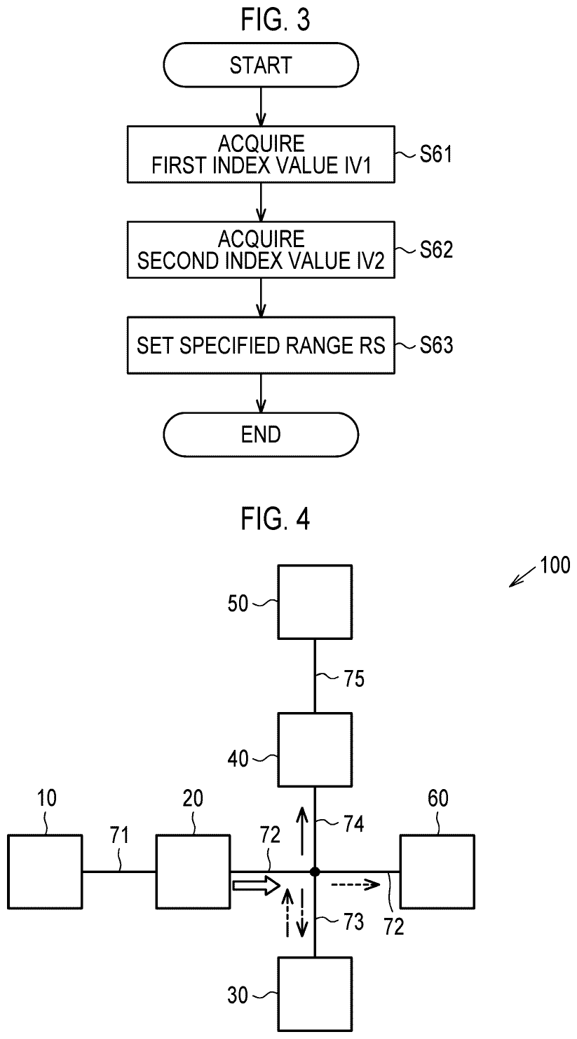

Next, setting control executed by the control device 90 will be described with reference to FIG. 3. The setting control is a control for setting a specified range RS that is a range of the input and output power to the low-voltage battery 30. In the present embodiment, the execution device 91 of the control device 90 starts the setting control for each predetermined control cycle.

As shown in FIG. 3, the execution device 91 of the control device 90 executes the process of S61 when the setting control is started. In S61, the execution device 91 acquires a first index value IV1 indicating the deterioration degree of the low-voltage battery 30. Here, the value of the first index value IV1 is larger as the deterioration degree of the low-voltage battery 30 is larger. In the present embodiment, the execution device 91 calculates the first index value IV1 based on the history of the battery temperature TB and the history of the use of the low-voltage battery 30 to acquire the first index value IV1. Specifically, the execution device 91 calculates a cumulative period of time for which the low-voltage battery 30 is used as a history of the battery temperature TB. The execution device 91 calculates the cumulative period in a state where the battery temperature TB is out of a predetermined appropriate temperature range from the time of manufacture of the low-voltage battery 30 to the time of the process of S61. In addition, the execution device 91 calculates a larger value as the first index value IV1 as the cumulative period is longer. The appropriate temperature range is a range of temperatures that is preferable as an environment in which the low-voltage battery 30 is used. In addition, the execution device 91 acquires a first number as a history of use of the low-voltage battery 30. The first number is the number of times of supplying the power from the solar panel 10 to the low-voltage battery 30 through the solar converter 20 from the time of manufacturing the low-voltage battery 30 to the time of processing of S61 in the power generation control. Further, the execution device 91 acquires a second number as a history of the use of the low-voltage battery 30. The second count is the number of times of supplying the power to the high-voltage battery 50 from the low-voltage battery 30 through the bidirectional converter 40 from the time of manufacturing the low-voltage battery 30 to the time of processing of S61 in the power generation control. Then, the execution device 91 calculates a larger value as the first index value IV1 as the first number is larger and as the second number is larger. After S61, the execution device 91 progresses the process to S62.

In S62, the execution device 91 acquires a second index value IV2 indicating a degree of whether or not the state in which the low-voltage battery 30 is placed is the state in which the deterioration is likely to occur. Here, the value of the second index value IV2 is larger as the state in which the low-voltage battery 30 is placed is more likely to deteriorate. In the present embodiment, the execution device 91 calculates the second index value IV2 based on the battery temperature TB to acquire the second index value IV2. Specifically, the execution device 91 calculates a larger value as the second index value IV2 as the battery temperature TB at the time of the process of S62 deviates from the predetermined appropriate temperature range. The appropriate temperature range is a range of temperatures that is preferable as an environment in which the low-voltage battery 30 is used. After S62, the execution device 91 progresses the process to S63.

In S63, the execution device 91 sets a specified range RS that is a range of input and output power to the low-voltage battery 30 based on the first index value IV1 and the second index value IV2. Specifically, the execution device 91 calculates a small value as an input upper limit value LI that is the upper limit value of the power input to the low-voltage battery 30 as the first index value IV1 is larger and the second index value IV2 is larger. Here, when the flow of the power input to the low-voltage battery 30 is used as a reference, the value of the input upper limit value LI is a positive value. In addition, the execution device 91 calculates a small value as an output upper limit value LO that is an upper limit value of the power output from the low-voltage battery 30 as the first index value IV1 is larger and the second index value IV2 is larger. Here, when the flow of the power output from the low-voltage battery 30 is used as a reference, the value of the output upper limit value LO is a positive value. In other words, when the flow of the power input to the low-voltage battery 30 is used as a reference, the value of the output upper limit value LO is a negative value. Therefore, when the flow of the power input to the low-voltage battery 30 is used as a reference, the input upper limit value LI corresponds to the upper limit value of the specified range RS. In addition, the output upper limit value LO corresponds to the lower limit value of the specified range RS. Therefore, the execution device 91 makes the specified range RS smaller as the first index value IV1 is larger and as the second index value IV2 is larger. In other words, the execution device 91 reduces the specified range RS when the first index value IV1 is the first value, as compared with when the first index value IV1 is the second value indicating that the deterioration degree of the low-voltage battery 30 is smaller than the first value. In addition, in a case where the second index value IV2 is the first value, the execution device 91 reduces the specified range RS as compared with a case where the second index value IV2 is a second value indicating that the low-voltage battery 30 is in a state in which the low-voltage battery 30 is less likely to deteriorate than the first value. After S63, the execution device 91 ends the current setting control.

### Operation of Present Embodiment

As shown by a bold arrow in FIG. 4, in the power generation control, the power generated by the solar panel 10 is supplied to the second power line 72 through the first power line 71 and the solar converter 20. Further, as indicated by the solid line arrow in FIG. 4, it is assumed that power is supplied to the high-voltage battery 50 through the fourth power line 74 and the bidirectional converter 40. Here, the power supplied from the solar converter 20 to the second power line 72 may be larger than the sum of the power input to the bidirectional converter 40 and the power input to the auxiliary equipment group 60. In such a case, as indicated by a one-dot chain line arrow in FIG. 4, power is input to the low-voltage battery 30. On the other hand, the power supplied from the solar converter 20 to the second power line 72 may be smaller than the sum of the power input to the bidirectional converter 40 and the power input to the auxiliary equipment group 60. In such a case, as indicated by a two-dot chain line arrow in FIG. 4, power is output from the low-voltage battery 30. As described above, the input and output power to the low-voltage battery 30 is changed by the power supplied from the solar converter 20 to the second power line 72, the power input to the bidirectional converter 40, and the power input to the auxiliary equipment group 60. In addition, it is assumed that the operation of the bidirectional converter 40 is stopped. In this case, the power input to the low-voltage battery 30 is changed by the power supplied from the solar converter 20 to the second power line 72 and the power input to the auxiliary equipment group 60. Therefore, in the vehicle 100, the magnitude of the input and output power to the low-voltage battery 30 may change due to various factors.

As shown in FIG. 3, in S61 in the setting control, the execution device 91 of the control device 90 acquires a first index value IV1 indicating the deterioration degree of the low-voltage battery 30. In S62, the execution device 91 acquires a second index value IV2 indicating a degree of whether or not the state in which the low-voltage battery 30 is placed is the state in which the deterioration is likely to occur. In S63, the execution device 91 sets a specified range RS that is a range of input and output power to the low-voltage battery 30 based on the first index value IV1 and the second index value IV2.

### Effect of Embodiment

(1) According to the present embodiment, in the setting control, the specified range RS is set based on the first index value IV1 and the second index value IV2. In the power generation control, the input and output power to the low-voltage battery 30 is adjusted in accordance with the specified range RS. As a result, the input and output power to the low-voltage battery 30 can be adjusted according to the first index value IV1 and the second index value IV2, in other words, according to the state of deterioration of the low-voltage battery 30.

(2) In the setting control, the execution device 91 reduces the specified range RS when the first index value IV1 is the first value, as compared with when the first index value IV1 is the second value indicating that the deterioration degree of the low-voltage battery 30 is smaller than the first value. Therefore, when the deterioration degree of the low-voltage battery 30 is large, the specified range RS is smaller than when the deterioration degree of the low-voltage battery 30 is small. As a result, in a case where the deterioration degree of the low-voltage battery 30 is large, in other words, the deterioration degree of the low-voltage battery 30 is not easily allowed to deteriorate further in a situation, the specified range RS can be reduced. In a case where the specified range RS is set to be small as described above, the deterioration of the low-voltage battery 30 can be suppressed as compared with a case where the specified range RS is set to be large.

(3) In the vehicle 100, as the number of times of supplying the power from the solar panel 10 to the low-voltage battery 30 through the solar converter 20 increases, the deterioration degree of the low-voltage battery 30 tends to increase. In addition, as the number of times of supplying the power from the low-voltage battery 30 to the high-voltage battery 50 through the bidirectional converter 40 increases, the deterioration degree of the low-voltage battery 30 tends to increase.

In this regard, in the setting control, the execution device 91 acquires a first number of times that is the number of times of supplying the power from the solar panel 10 to the low-voltage battery 30 through the solar converter 20 in the power generation control, in acquiring the first index value IV1. Further, the execution device 91 acquires a second number of times that is the number of times of supplying the power to the high-voltage battery 50 from the low-voltage battery 30 through the bidirectional converter 40 in the power generation control. Then, the execution device 91 calculates a larger value as the first index value IV1 as the first number is larger and as the second number is larger. As a result, the first index value IV1 can be acquired based on the value closely related to the deterioration degree of the low-voltage battery 30.

(4) In the setting control, the execution device 91 reduces the specified range RS when the second index value IV2 is the first value, as compared with when the second index value IV2 is the second value indicating that the low-voltage battery 30 is less likely to deteriorate than the first value. Therefore, in a case where the low-voltage battery 30 is likely to deteriorate, the specified range RS is smaller than in a case where the low-voltage battery 30 is less likely to deteriorate. As a result, in a case where the low-voltage battery 30 is likely to deteriorate, in other words, the specified range RS can be reduced in a situation in which the load on the low-voltage battery 30 is to be suppressed. In a case where the specified range RS is set to be small as described above, the deterioration of the low-voltage battery 30 can be suppressed as compared with a case where the specified range RS is set to be large.

(5) As shown in FIG. 2, in the setting control, the execution device 91 proceeds to S31 in a case where power is input to the high-voltage battery 50 through the bidirectional converter 40 and power from the solar panel 10 is input to the low-voltage battery 30 through the solar converter 20. In S31, the execution device 91 controls the power input to the high-voltage battery 50 through the bidirectional converter 40 to adjust the power input to the low-voltage battery 30 to be equal to or less than the input upper limit value LI. In addition, in a case where power is input to the high-voltage battery 50 through the bidirectional converter 40 and power from the solar panel 10 is not input to the low-voltage battery 30 through the solar converter 20, the execution device 91 proceeds the process to S32. In S32, the execution device 91 controls the power input to the high-voltage battery 50 through the bidirectional converter 40 to adjust the power output from the low-voltage battery 30 to be equal to or less than the output upper limit value LO. In a case where the bidirectional converter 40 is operated as described above, the input and output power to the low-voltage battery 30 is adjusted by controlling the bidirectional converter 40. Therefore, for example, the change in the conversion efficiency of the solar converter 20 due to the adjustment of the input and output power to the low-voltage battery 30 is suppressed as compared with the case where the solar converter 20 is controlled. As a result, it is possible to suppress the power supplied from the solar converter 20 to the second power line 72 from being reduced due to the adjustment of the input and output power to the low-voltage battery 30.

Further, the execution device 91 proceeds the process to S51 in a case where the bidirectional converter 40 is not operated and the power from the solar panel 10 is input to the low-voltage battery 30 through the solar converter 20. In S51, the execution device 91 controls the power output from the solar converter 20 to the second power line 72 to adjust the power input to the low-voltage battery 30 to be equal to or less than the input upper limit value LI. In a case where the bidirectional converter 40 is not operated as described above, the solar converter 20 is controlled to adjust the power input to the low-voltage battery 30. Therefore, the power input to the low-voltage battery 30 can be adjusted even in a situation where the bidirectional converter 40 is not operating.

### Modification Example

The present embodiment can be modified and carried out as follows. The present embodiment and the following modification examples can be carried out in combination within a technically consistent range.

In the above-described embodiment, the power generation control may be changed. For example, in S11, the manner of acquiring the generated power value PG may be changed. As a specific example, the execution device 91 may acquire the value of the power supplied from the solar converter 20 to the second power line 72 as the generated power value PG.

For example, in S31, the way of adjusting the power input to the low-voltage battery 30 may be changed. As a specific example, the execution device 91 may control the solar converter 20 instead of or in addition to controlling the bidirectional converter 40. That is, the execution device 91 may adjust the power input to the low-voltage battery 30 to be equal to or less than the input upper limit value LI by controlling the power output from the solar converter 20 to the second power line 72.

For example, in S32, the way of adjusting the power output from the low-voltage battery 30 may be changed. As a specific example, it is assumed that there is a room for increasing the power output from the solar converter 20 to the second power line 72 at the processing point of S32. In this case, the execution device 91 may control the solar converter 20 instead of or in addition to controlling the bidirectional converter 40. That is, the execution device 91 may adjust the power output from the low-voltage battery 30 to be equal to or less than the output upper limit value LO by controlling the power output from the solar converter 20 to the second power line 72.

For example, in S41, the bidirectional converter 40 may be operated. As a specific example, in a case where the power needed for the auxiliary equipment group 60 is relatively large, in S41, the execution device 91 may step down the power input to the bidirectional converter 40 through the fifth power line 75 and supply the power to the fourth power line 74. In the above case, in S51, the execution device 91 may control the bidirectional converter 40 instead of or in addition to controlling the solar converter 20. That is, the execution device 91 may adjust the power input to the low-voltage battery 30 to be equal to or less than the input upper limit value LI by controlling the power output from the bidirectional converter 40 to the fourth power line 74.

In the above-described embodiment, the setting control may be changed. For example, in S61, the way of acquiring the first index value IV1 may be changed. As a specific example, the execution device 91 may acquire the first index value IV1 by calculating the first index value IV1 based on solely one of the history of the battery temperature TB and the history of the use of the low-voltage battery 30. As a specific example, the execution device 91 may acquire the first index value IV1 by calculating the first index value IV1 based on another value instead of or in addition to the history of the battery temperature TB and the history of the use of the low-voltage battery 30. An example of the other value is the total number of times of input and output of the power to the low-voltage battery 30, the history of the input and output of the current to the low-voltage battery 30, and the history of the inter-terminal voltage of the low-voltage battery 30 from the point in time of the manufacturing of the low-voltage battery 30 to the point in time of the processing of S61. In addition, another example of the above another value is the battery capacity of the low-voltage battery 30 and the internal resistance of the low-voltage battery 30 at the time of the process of S61.

For example, in S62, the way of acquiring the second index value IV2 may be changed. As a specific example, the execution device 91 may acquire the second index value IV2 by calculating the second index value IV2 based on another value instead of or in addition to the battery temperature TB. An example of the other value is the inter-terminal voltage of the low-voltage battery 30, the charge rate of the low-voltage battery 30, and the temperature around the low-voltage battery 30 at the time of the process of S62.

For example, in S63, the way of setting the specified range RS may be changed. As a specific example, the execution device 91 may reduce the specified range RS when the first index value IV1 is equal to or higher than a predetermined first reference value as compared with a case where the first index value IV1 is less than the first reference value. As a specific example, the execution device 91 may reduce the specified range RS when the second index value IV2 is equal to or higher than the predetermined second reference value, as compared to when the second index value IV2 is lower than the predetermined second reference value.

In the above-described embodiment, the configuration of the vehicle 100 may be changed. For example, the configuration of the control device 90 may be changed. Specifically, the control device 90 may be configured as a circuitry including one or more processors that execute various processes in accordance with a computer program (software). The control device 90 may be configured as a circuit including one or more dedicated hardware circuits, such as an application-specific integrated circuit (ASIC), which executes at least a part of various types of processing, or a combination thereof. The processor includes a CPU and a memory, such as a RAM and a ROM. The memory stores a program code or an instruction configured to cause the CPU to execute the processing. The memory or the computer-readable medium includes any medium that can be accessed by a general-purpose or dedicated computer.

In the above-described embodiment, the charging system is not limited to the vehicle 100. For example, the charging system can be applied to a device other than the vehicle 100, a building, and the like.

What is claimed is:

1. A control device for a charging system comprising:
a solar panel configured to generate power by receiving irradiation of sunlight;
a first converter configured to convert a voltage of the power from the solar panel and output voltage-converted power;
a low-voltage battery configured to be charged by receiving the power from the first converter;
a second converter configured to convert a voltage of the power from the first converter and a voltage of power from the low-voltage battery and output voltage-converted power; and
a high-voltage battery configured to be charged by receiving the power from the second converter, wherein the control device is configured to execute:
acquiring a first index value that indicates a deterioration degree of the low-voltage battery;
acquiring a second index value that indicates a degree of whether a state in which the low-voltage battery is placed is a state in which the low-voltage battery is likely to deteriorate; and
setting a specified range that is a range of input and output power with respect to the low-voltage battery based on the first index value and the second index value.

2. The control device according to claim 1, wherein the control device is configured to execute, in a case where the first index value is a first value, reducing the specified range as compared with a case where the first index value is a second value indicating that the deterioration degree of the low-voltage battery is smaller than the first value.

3. The control device according to claim 2, wherein the control device is configured to execute, in the acquiring of the first index value, calculating the first index value based on the number of times of supplying the power from the solar panel to the low-voltage battery through the first converter and the number of times of supplying the power from the low-voltage battery to the high-voltage battery through the second converter.

4. The control device according to claim 1, wherein the control device is configured to execute, in a case where the second index value is a first value, reducing the specified range as compared with a case where the second index value is a second value indicating that the low-voltage battery is in a state in which the low-voltage battery is less likely to deteriorate than in a state of the low-voltage battery of the first value.

5. The control device according to claim 1, wherein the control device is configured to execute:
in a case where the power is input to the high-voltage battery through the second converter and the power from the solar panel is input to the low-voltage battery through the first converter, adjusting the power input to the low-voltage battery by controlling the power input to the high-voltage battery through the second converter;
in a case where the power is input to the high-voltage battery through the second converter and the power from the solar panel is not input to the low-voltage battery through the first converter, adjusting the power output from the low-voltage battery by controlling the power input to the high-voltage battery through the second converter; and
in a case where the second converter is not operated and the power from the solar panel is input to the low-voltage battery through the first converter, adjusting the power input to the low-voltage battery by controlling the power output from the first converter.
